(19) United States
(12) Patent Application Publication
(10) Pub. No.: US 2009/0240632 A1
(43) Pub. Date: Sep. 24, 2009

(54) METHOD AND APPARATUS FOR MONITORING A BROKERAGE ACCOUNT

(76) Inventors: JOSEPH MICHAEL CUNNINGHAM, Woodstock, GA (US); James Nickel Friedman, Alpharetta, GA (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/408,020

(22) Filed: Mar. 20, 2009

Related U.S. Application Data
(60) Provisional application No. 61/038,171, filed on Mar. 20, 2008.

(51) Int. Cl. G06Q 40/00

(52) U.S. Cl. 705/36 R

(57) ABSTRACT

The present invention is directed to methods and systems for determining whether brokerage accounts encompassing volatile portfolios maintain sufficient capital reserves under scenarios reflecting a variety of risk factors. The present invention provides methods to concurrently calculate volatility based margining requirements and value at risk.

### RELATED APPLICATIONS

This application claims the benefit of provisional application No. 61/038,171 filed on Mar. 20, 2008, incorporated herein by reference in its entirety.

### BACKGROUND OF THE INVENTION

A. Field of Invention

The present invention is directed to methods for assuring that brokerage accounts encompassing volatile portfolios maintain sufficient capital reserves. The methods are particularly applicable to Forex brokers and investors dealing in margin accounts with the goal of maximizing individual profit of each asset.

B. Description of the Prior Art

1. The Purpose of Margin

Presently, investors are permitted to invest in leveraged financial instruments (“LFIs”) with only a percentage of the notional value and may “margin” the remainder. The paid-out money is considered to be the on-hand collateral. Presently, minimum collateral must be on-hand relative to the total investment value to meet regulatory and dealing compliance requirements. Margining is defined as the entire process of measuring, calculating and administering this minimum collateral that must be made available for coverage of open positions within a portfolio. The minimum collateral requirement is intended to ensure that all financial commitments relating to the open positions of a dealing entity may be offset within a very short period of time. From the perspective of the individual investor, in the event that the portfolio value falls, more collateral is needed or some assets must be sold. Conversely, in the event that the portfolio value rises, although the collateral is offset by the increase in value of the portfolio, the risk of “under coverage” grows. In general, because the requisite collateral (in dollars) necessarily varies as the value of the underlying assets varies, volatility can have devastating consequences to an investor or an asset manager.

Although the initial margin requirement is fixed as a percentage of value of the underlying asset, the goal of margining is to have sufficient capital on hand such that the investor optimally accounts for anticipated price fluctuations. Under an aggressive investment strategy, the total investment value is managed without the need to actively manage the margin requirement. The value of collateral which must be held in reserve is calculated based on 1) the risk exposure of the total portfolio and 2) its individual constituent parts. Risk exposure itself is calculated based upon open positions, cash balances, and market volatility. The risk mitigating effect of combinations of positions is considered in this calculation—equal but opposite positions within the account offset each other. The goal is to achieve an optimal degree of security with a minimum amount of collateral. In order to meet this goal, a risk analysis model may be implemented for assessing requisite margin with appropriate risk management strategies being enacted within the method.

2. Forms of Margin Assessment

Some standard forms of risk analysis models used to assist in determining margin are described below:

a—Conditional Value-at-Risk

Some approaches calculate margin based upon the variance of a normal distribution. For example, Agarwal and Naik (Risks and Portfolio Decisions Involving Hedge Funds”, Review of Financial Studies 17(1), 63-98, 2004) recommend applying a Conditional Value-at-Risk (CVaR) framework particularly to hedge funds. A CVaR framework captures the left-tail risk, or the amount of risk should the underlying asset decrease, of those hedge fund strategies that have short put option-like exposures. However, the authors additionally show that the application of this mean-variance framework in the case of some hedge fund strategies can result in underestimation of tail risk by as much as 50% of the total asset value being measured at risk.

b—Modified Value-at-Risk

Signer and Favre (Journal of Alternative Investments, 2002) propose a risk measure that also considers the distribution but additionally takes the third and fourth moments of an investment's distribution into consideration. Skewness is the third moment, which describes how asymmetric a distribution is, and kurtosis is the fourth moment, which is linked to the existence of extreme returns. They describe a statistical method to incorporate skewness and kurtosis; they refer to this new measure as “Modified VAR” (MVaR).

Both CVaR and MVaR have drawbacks in practical applications, such as for market makers, such as in Foreign Exchange. As an example, a drawback for these methods is in their inability to provide accurate statistical inferences where the population of transactions within a portfolio is small relative to the population of transactions. Market-makers typically do not hold such a representative sampling of the market. The three most widely used applications for margining LFI are Delta Margining, Risk-based Margining, and Standardized Portfolio Analysis of Risk (SPAN).

c—Delta Margin

The “Delta Margin” approach may be used to determine requisite margin relative to each spot contract. Delta Margin provides an indicator of how a particular option's value changes relative to a change in an underlying asset, That is, Delta Margin is applied on an investment-by-investment basis. However, when a portfolio includes potentially positively and negatively changing positions, because Delta Margin is applied to individual investments, Delta Margin becomes less useful than expected. A portfolio that is analyzed for net difference could remove a margin requirement for positions whose combined differences summed to zero. Although the Delta Margin approach could be modified by adding requirements for positive and negative changes as absolute values, such an approach generally overvalues the requisite margin.

d—Risk-Based Margining

Additional schemes include those described in SECURITIES AND EXCHANGE COMMISSION (Release No. 34-54918, File No. SR-NYSE-2006-13 of Dec. 12, 2006 (http://www.sec.gov/rules/sro/nyse/2006/34-54918.pdf), and Release No. 34-54919, File No. SR-CBOE-2006-14 of Dec. 12, 2006 (http://www.sec.gov/rules/sro/cboe/2006/34-54919.pdf) for Risk-based Margining. Essentially, portfolios are grouped into baskets of like underlying assets and “shocked” to determine the realistic maximum potential loss to the basket given a daily fluctuation in the value of the underlying asset. This approach is similar to the Delta Margin approach in that it is focused on individual investments. The shock raises and lowers the value of each underlying asset, but fails by not accounting for changes in volatility within a collection of investments.

e—SPAN

A risk-based margining developed by the Chicago Mercantile Exchange is called SPAN (standardized portfolio analysis of risk). Futures exchanges predetermine the amount of margin required for trading a futures contract, which is based on daily limit prices set by the exchanges. Therefore, the predetermined amount of margin required allows the exchange to know what a ‘worst-case’ one-day move might be for any open futures position (long or short). A risk analysis accounts for up and down changes in volatility and a change in the underlying asset based upon several scenarios, and these are built into “risk arrays.” Based on these worst-case variables, a risk array is created for each futures option strike price and futures contract. A worst-case risk array for a short call, for example, would be at a futures limit with volatility up. Obviously, a short call will suffer from losses from an extreme (limit) move up of the underlying futures and a rise in volatility. SPAN margin requirements are determined by a calculation of possible losses. Unlike the earlier approaches, the uniqueness of SPAN establishes margin requirements based on the entire portfolio and not just the last trade. The problem with SPAN is its reliance on a single entity to deploy risk arrays for each option strike price. This approach is impractical for dealing entities wishing to manage their individual tolerance for risk.

To summarize, while several methods of managing margining risks are known in the field, each have severe limitations and therefore there is a need for a margining risk management system that overcomes the disadvantages of the prior art. Moreover there is a need for a scheme of this type that can readily implemented on an automated electronic apparatus.

### SUMMARY OF THE INVENTION

The present invention is directed to methods and an apparatus for assuring that brokerage accounts encompassing volatile portfolios maintain sufficient capital reserves. The methods are particularly applicable to brokers and investors dealing in margin accounts with the goal of maximizing individual profit of each asset. Underlying the present invention is the understanding that brokers aim to protect their customer portfolios and to retain the ability to trade assets without the need to actively adjust portfolios for meeting increasing margin requirements. When the customer portfolio is protected by securing sufficient capital reserves in an investment portfolio associated with high risk and volatility, any trading must concurrently protect stakeholder investment while maximizing the investor's profit. The balance in managing these divergent desires has recently been exacerbated by increased volatility as a consequence of greater market participation by speculators, hedge fund managers, as well as by institutions.

As in economics and finance, Value at Risk (VAR) is defined here as the maximum loss not exceeded with a given probability, defined as the confidence level, over a given period of time. In the field of the invention, numerous methodologies are used for calculating VAR, some of which are detailed below. No matter which methodology was used, until recently, investors calculated Value at Risk (VAR) metrics separately from margining. The present invention provides for a method for concurrently calculating Volatility-Based Margining (VBM) and VAR, such that a portfolio may be assured of having adequate margin on hand based on the combined desires of protecting stakeholder investment and maximizing profit. In particular, the present invention provides for a method and apparatus using concurrent assessments of multiple risk scenarios.

### BRIEF DESCRIPTION OF THE DRAWINGS

FIG. 1 shows a three dimensional graph with risk being plotted on a volatility surface;

FIG. 2 shows a graph of the distribution associated with of a ±2% price change;

FIG. 3 shows a risk assessment charge chart;

FIG. 4 shows a typical CUP (Current Underlying Price) parameter array;

FIG. 5 shows a volatility-based margin flow chart;

FIG. 6 shows a value-at-risk flow chart; and

FIG. 7 shows a block diagram of an apparatus used to implement the invention.

### DETAILED DESCRIPTION OF THE INVENTION

A. Overall Objective and Approach

The primary objective behind volatility-based margining is to determine the largest reasonable one-day loss that a portfolio of options might experience and to assure adequate margin is on hand and enacting appropriate procedures to cover risk. The reasonable loss is determined using industry-standard option pricing models, identifying numerous market scenarios across a wide range of realistic conditions, and evaluating the portfolio's potential fluctuation.

B. Volatility-Based Margining (VBM)

The present invention provides for an improved margining method and apparatus that takes advantage of a calculation of an enhanced VBM metric. The invention encompasses concepts of both risk-based margining and SPAN as these terms are defined above, and also provides flexibility for the market maker to continually evaluate the portfolio under ever changing volatility. Value-at-risk (VAR) is defined as the value of the total portfolio that is at risk should changes occur in the underlying asset. These changes used in evaluating the VAR must be user selectable. Value-at-risk is continually calculated in the present invention. The present invention additionally allows brokers having customers/clients/accounts with varying risk tolerances with the ability to deploy VBM in a practical manner concurrently across all clients. Finally, unlike the prior art, the present invention provides for a methodology for combining the benefits of VAR within variance analysis.

Volatility-Based Margining initially implements a multi-dimensional risk surface model to calculate value at risk. The first surface dimension defines the upper and lower asset class movement. This first dimension is determined by the standard margin rate for the spot asset. The second surface dimension defines the upper and lower volatility movement based on setting to zero for one end of the scale and doubling the current At-The-Money volatility for the other end of the scale. The present invention allows for either a fixed amount of margin or a calculated amount using a percentage of the notional value of the contract with to determine the upper and lower ends of the scale.

Another feature that sets this enhanced method apart is in its use of VAR. By having consistent implementation of VBM and VAR, a broker obtains a consistent understanding of his risk being covered by margin. Because the VAR model can use a different margin parameter, the broker establishes a VAR/VBM variance to analyze their variance of risk and margin. No other system currently ties in the two so uniquely.

Volatility-Based Margining (“VBM”) provides a method for determining the required margin deposit (or “good faith money”) for trading in leveraged financial instruments, particularly same-account foreign exchange spot and options trading. VBM is designed to encumber accountholder funds that: 1) equal to only an amount of money that reflects the actual aggregate risk bore by the open positions in the account, and 2) protects the margin broker from customer risk exposure to all but statistically unlikely changes in the market price of those open positions. VBM is also designed to produce actions to ensure Value-At-Risk (VAR) does not exceed risk parameters.

The next step for VBM is to encumber accountholder funds by the amount of money to be held as good faith deposit towards risk mitigation. If the amount is insufficient, then initiated transactions are aborted, or existing open positions are offset in order to satisfy the VBM established requirement. On a dealing portfolio spanning multiple accountholders, VBM will execute or offset hedge transactions used by the dealing principal. The final step for VBM is to notify the actions taken or aborted as a result of its evaluations.

The present invention further includes a software implementation of the aforementioned approach. The user enters attributes of a portfolio, including on-hand marginable capital and tolerance for risk. The program extracts real time or near real time data from public sources using these data for its calculations. The software program permits a display to appear to a broker, indicating real time investment status and options, based on real time or near real time pricing. Alerts and actionable events are provided to users as investment variabilities approach margin limits.

C. Parameters for Calculating Volatility-Based Margining (VBM)

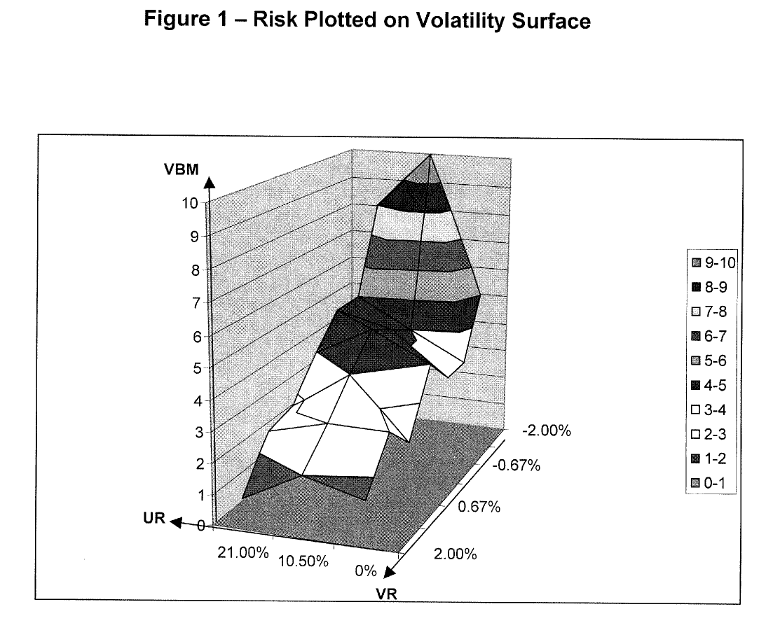

The two parameter values that are needed for performing a volatility-based margin calculation are Underlying Range (UR) and Volatility Range (VR). The Underlying Range is defined as twice the notional value of the contract multiplied by the margin percent if a percentage is used or two times the margin value if a fixed amount is used. The Volatility Range is twice the current At-the-Money volatility parameter. The Volatility Range is set according to current market conditions of the respective contracts. A typical relationship between VBM, UR and VR is illustrated in FIG. 1.

As there is no central exchange for certain transactions, such as OTC Forex option transactions, the input parameters necessary to perform volatility-based margin calculations, conservative parameters for these transactions can be inferred, however, from generally accepted deposit requirements. Furthermore, when used as percentages of notional value, these parameters do not need to be adjusted as prices fluctuate.

Because market fluctuations rarely exceed 2% per day, a generally accepted margin requirement for many transactions (e.g., FOREX transactions) is 2% of notional value and occasionally 4%, under extreme conditions in the market such as collapse, insolvency or significant financial event of a major central bank like the Bank of England or Bank of Japan (as examples). Similarly, performance bond requirements for the Chicago Mercantile Exchange currency futures contracts are also at about 2% of contract value.

These security deposit levels are set with the assumption that in most trading sessions, market price movement will not exceed these ranges. Thus, these values can be used as reasonable Underlying Ranges.

Assuming that a 2% or more one-day price change in the underlying market represents a three standard deviation (3σ) event, such an event would occur once every 370 trading sessions on average, because the probability of a 3σ or greater event for a normal distribution is 0.27% ( 1/0.0027=370.4). Based on this calculation, the underlying market has a one-day price change distribution with a standard deviation of approximately 0.67%. This value is derived from 2% Range/3σ=0.666%. For those currency pairs with a security deposit of 4%, we similarly assume a one-day price move distribution with a standard deviation of 1.333%. (4% Range/3σ=1.333%).

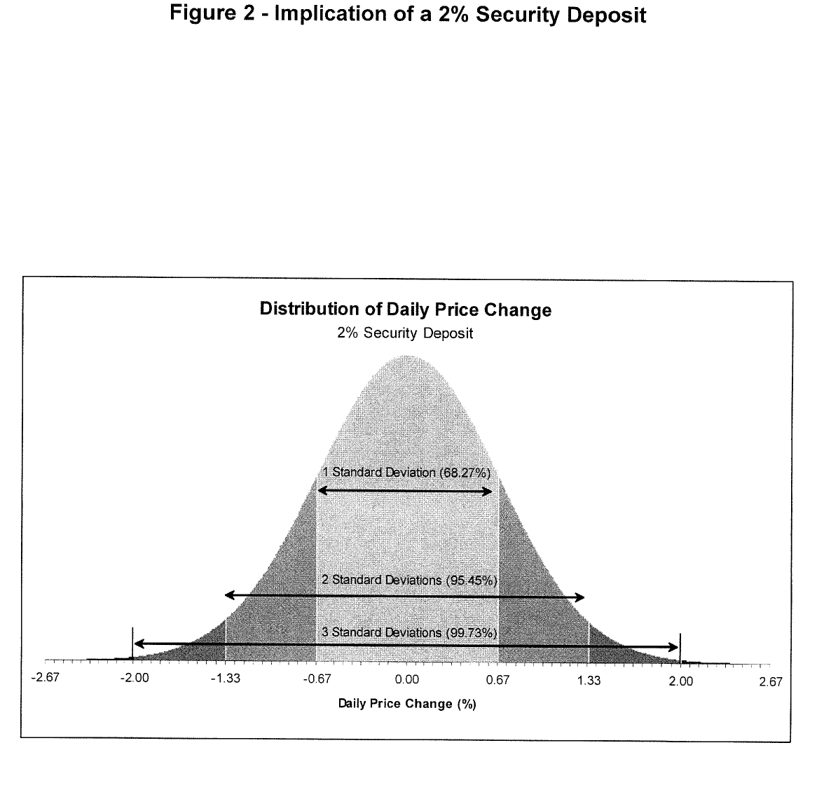

FIG. 2 shows a normal (“bell-shaped”) one-day price change distribution with a 0.67% standard deviation. Price change distributions are usually assumed to be lognormally distributed. For a one-day price change, however, the difference between normal and lognormal distribution assumptions is minimal.

A volatility range needs to be established based upon a reasonable expectation of volatility. A one-day price change distribution with a standard deviation of 0.67% implies an annual price change distribution with a standard deviation (volatility) of approximately 10.5%. (Natenberg, Sheldon, Option Volatility and Pricing Strategies: Advanced Trading Techniques for Professionals, 1st ed. (Chicago: Probus, 1988), Pg. 344). Assuming 252 trading sessions in a year, annualized volatility=(2%/3)*√252=10.58%. Thus, 10.5% volatility is consistent with the current security deposit requirement of 2% of notional value. For those currency pairs with a security deposit of 4%, the annualized volatility=(4%/3)*√252=21.17%.

However, to assess the risk associated with extreme price movements the volatility range must be viewed conservatively. An adequate lower value for the volatility range is 0.0%. Using 0.0% in the option calculations has the effect of valuing all options at their intrinsic values. This approach is consistent with “position-based” margining rules, which were the standard before more robust methods were developed. For long option positions, this valuation results in a margin level paying a 100% premium, that is, full market price for an option. In addition, for simple option spreads, using 0.0% volatility results in margin requirements equal to the maximum loss that the spread can experience.

An adequate upper value for the reasonable volatility range is 21.0%. For those currency pairs with a security deposit of 4%, the upper volatility range value would be double the value of the current security deposit requirement at 2% of notional value, or 42.0%. In addition to the intuitive notion of using twice the baseline volatility of 10.5%, the 52-week historical volatility for the major currencies has remained below 21.0% since January 2000.

Volatility-based margining also requires calculations for Risk Assessment Charge and Short Option Minimum Charge. Total margin charge is the greater of these two values.

D. Risk Assessment Charge

Option portfolios are analyzed at each of 16 market scenarios. These 16 scenarios reflect a wide range of conditions within the upper and lower limits of each of the scales of volatility and change in underlying asset.

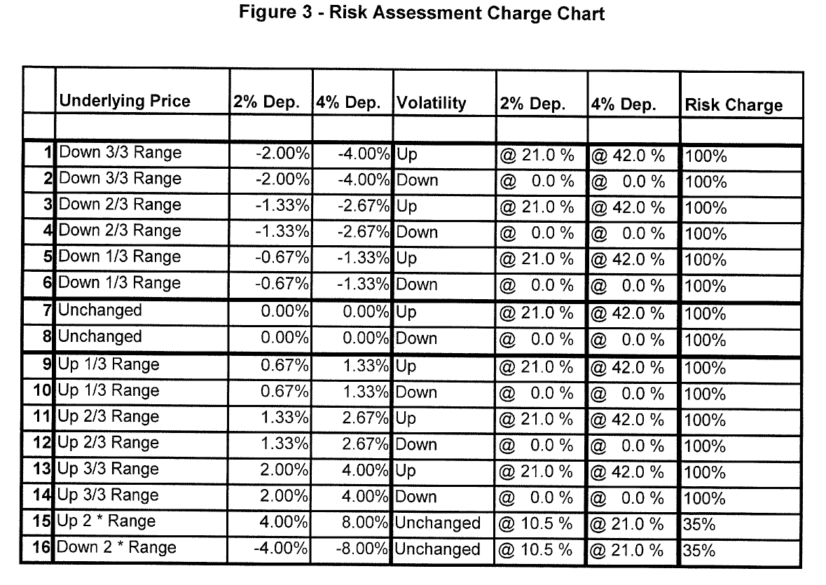

FIG. 3 shows a generalized series of inputs for the 16 market scenarios. Scenarios 15 and 16 are included to assess the risk of far out-of-the-money short options that would not fall within the maximum one-day price change. Because of the unlikely event of these options becoming in-the-money, the risk margin associated with these two scenarios are only charged at 35% of the others.

The Risk Assessment Charge for the portfolio of options is the greatest loss seen across the 16 scenarios.

E. Short Option Minimum Charge

Even with the conservative values for Underlying Range and Volatility Range outlined above, deep out-of-the-money short options may not produce any significant risk charges when evaluating the 16 risk scenarios. To be consistent with other volatility-based margining methods in use worldwide, there is a Short Option Minimum Charge. This is simply an additional risk charge of 0.05% of notional value for each short option in the portfolio.

F. Volatility-Based Margining Benefits

VBM ties together margining and value-at-risk. In using the present invention to calculate VBM together with VAR, an investor has the ability to see consistency in the presenting margin to the customer and in assessing risk in the customer portfolio. In addition, the present invention implements VAR with an alternative parameter to increase or decrease the resulting value (or what-if scenario). The portfolio is quickly revalued with a substitute volatility parameter without modifying the customer margins. Should the new parameter be deemed appropriate, the customer margins can then be adjusted accordingly.

G. A Method for Calculating Volatility-Based Margin (VBM)

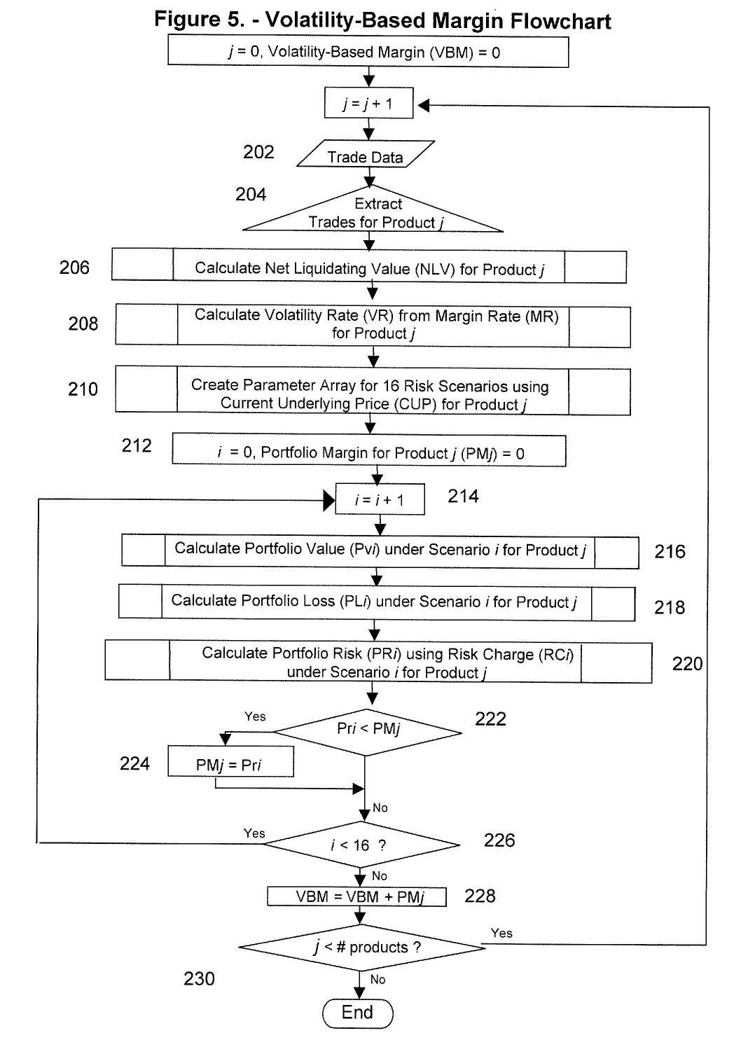

The actual calculation of VBM is shown in the flow chart of FIG. 5.

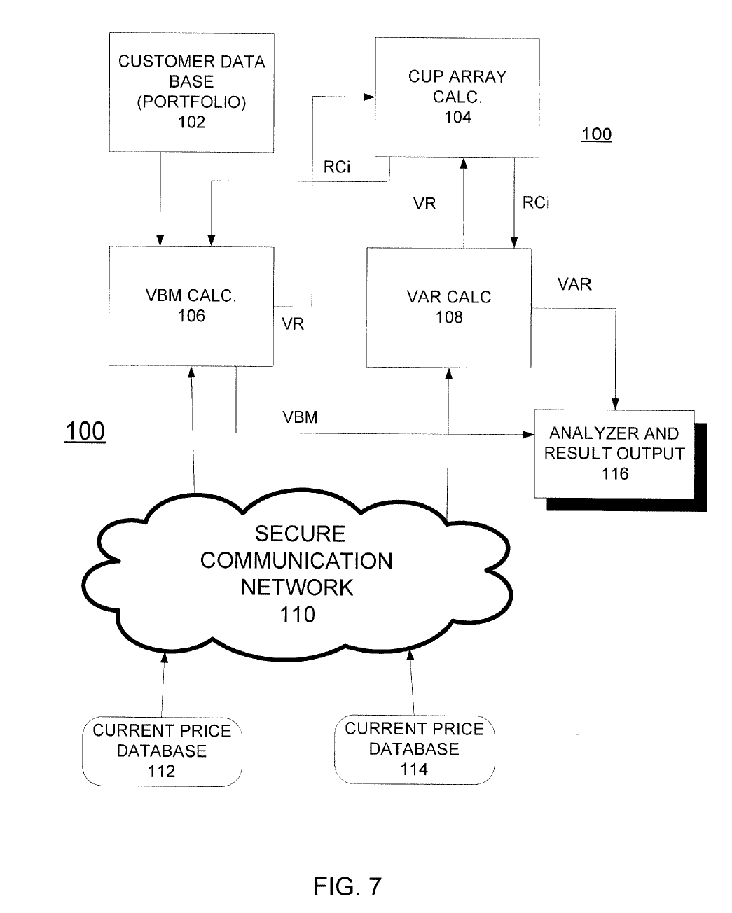

FIG. 7 shows a block diagram of an apparatus used for determining the parameters VBM and VAR. The apparatus 100 includes a CUP array calculator 104, a VBM calculator 106 and a VAR calculator 108. These elements receive information regarding the current assets (including both instruments and cash) for one or more clients—generally referred to as portfolios. The apparatus 100 further communicates through a secure communication network 110 (that may include the Internet or an intranet) to several current price databases 112, 114. These databases provide at regular intervals or in request the current prices of various instruments.

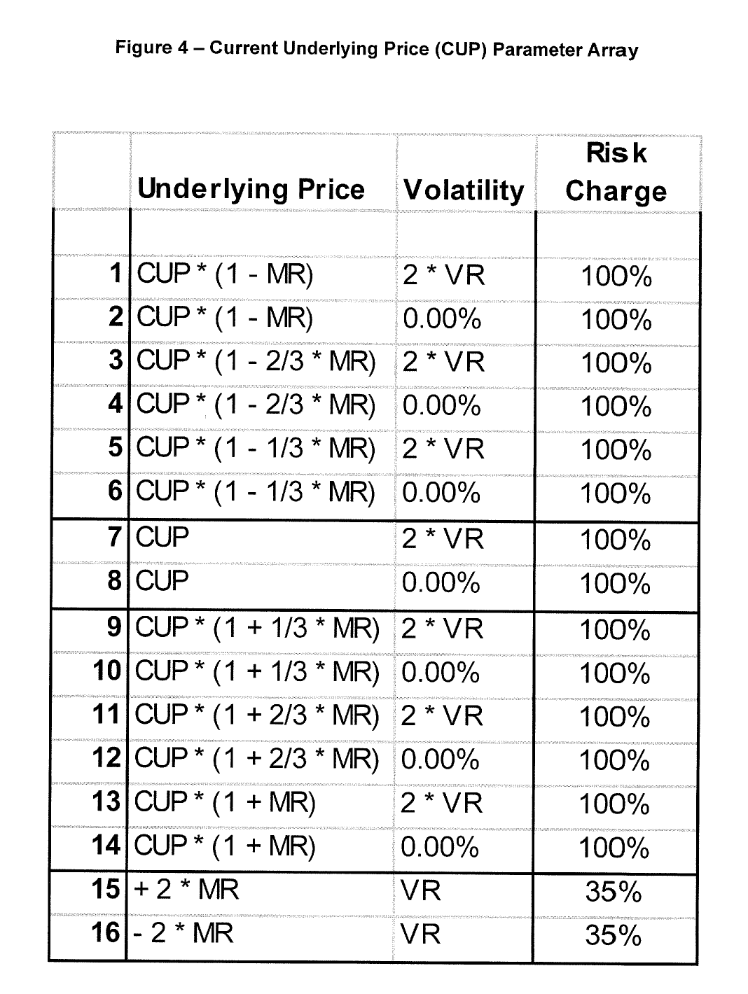

Details of the VBM is calculated by the apparatus 100 are now described in conjunction with the flow chart of FIG. 4. Initially various pointers and intermediate parameters are at their preset value (usually 0) as shown by the VBM calculator 106. In step 202 the current trade data is obtained from databases 112, 114.

In step 204 the trades for a specific product j is extracted from the data obtained in step 202.

In step 206, the Net Liquidating Value (NLV) is calculated as the value received plus any cash on hand should every transaction within the portfolio become liquidated at the current prevailing market value.

In step 208 the Volatility Rate (VR) is calculated from the Margin Rate (MR); VR=(MR/3)√252, where MR is a well known parameter in the industry.

In step 210 the parameter array for the 16 risk scenarios are created as shown in FIG. 4 using Current Underlying Price (CUP) calculator 104.

In steps 212 the parameters I and PMj are reset and in step 216 the current Portfolio Value (PVi) for each of the 16 risk scenarios is calculated.

(i=1 to 16)

In step 218 the Portfolio Loss (PLi) is calculated for each of the 16 risk scenarios:

PLi=min (0, NLV−PVi). (i=1 to 16)

In step 220 the Portfolio Risk (PRi) for each of the 16 risk scenarios is calculated using the Risk Charge (RCi) parameter.

PRi=PLi*RCi. (i=1 to 16)

In steps 222-226 the largest (most negative) Portfolio Risk among the 16 scenarios as Portfolio Margin (PM) for product j is chosen using:

PMj=min (PRi). (i=1 to 16) Across all products

In step 228 the total Volatility-Based Margin (VBM) is calculated by summing Portfolio Margins:

VBM=Σ(PMj) (j=1 to number of products).

In step 230 a check is performed to determine if the calculations have been performed for all j products. The resulting total parameter VBM is then provided to an analyzer and result output element 116 in FIG. 5.

Method for Calculating Value-at-Risk (VaR).

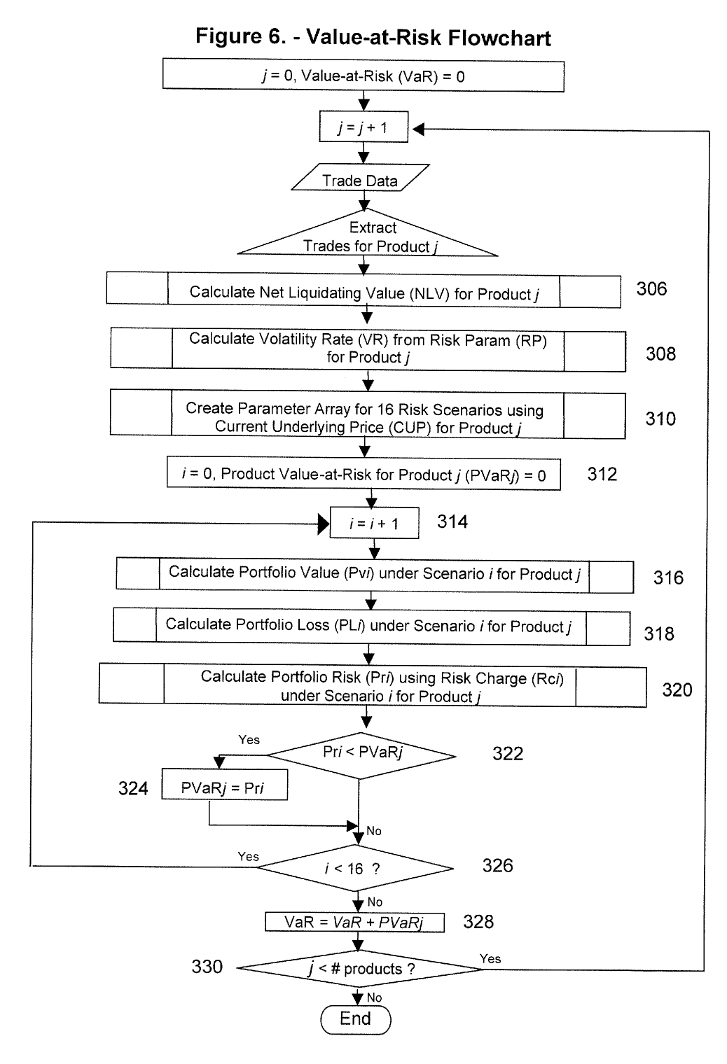

The calculation of VaR is performed by the VAR calculator 108 using a very similar process as shown in the flow chart of FIG. 6.

Step 306—Calculate the Net Liquidating Value (NLV). The NLV is calculated as the value received plus any cash on hand should every transaction within the portfolio become liquidated at the current prevailing market value.

Step 308—Calculate the Volatility Rate (VR) from the Risk Parameter (MR).

VR=(RP/3)*√252.

Step 310—Create the parameter array for the 16 risk scenarios using Current Underlying Price (CUP), as depicted in FIG. 4.

Steps 312-316 Calculate the Portfolio Value (PVi) for each of the 16 risk scenarios.

(i=1 to 16)

Step 318 Calculate the Portfolio Loss (PLi) for each of the 16 risk scenarios:

PLi=min (0, NLV−PVi). (i=1 to 16)

Step 320 Calculate the Portfolio Risk (PRi) for each of the 16 risk scenarios using the Risk Charge (RCi).

PRi=PLi*RCi. (i=1 to 16)

Steps 322-326—Choose the largest (most negative) Portfolio Risk among the 16 scenarios as Product Value-at-Risk (PVaR) for product j:

PVaRj=min (PRi). (i=1 to 16) Across all products,

Step 326—Calculate total Value-at-Risk (VaR) by summing Portfolio Margin.

VaR=Σ(PVaRj) (j=1 to number of products)

The parameter VaR is then provided to the analyzer and result output 116 as well.

To summarize, the present invention is used to calculate two parameters, or values the Volatility-Based Margining (VBM) and the Value-at-Risk (VaR).The two parameters or values are then presented to the broker so that he can determine what the status or position of the account. Alternatively, the two values are used in various other manual, semiautomatic or automatic operations

VBM can be regarded as the required margin deposit (or “good faith money”) for trading in leveraged financial instruments, particularly same-account foreign exchange spot and options trading. VBM is designed to yield a margin deposit amount that: 1) requires the accountholder to encumber only an amount of money that reflects the actual aggregate risk bore by the open positions in the account, and 2) protects the margin broker from customer risk exposure to all but statistically unlikely changes in the market price of those open positions. The result of the VBM calculation determines the amount of money to be held as good faith deposit towards risk mitigation in a customer's account. If the amount is insufficient, then certain transactions will either be aborted, or offset in order to satisfy the VBM established requirement.

There are several different ways of using the parameter VBM. In one embodiment, an accountholder wishes to initiate transactions in his account. The broker then uses the system described above and the VBM is calculated for both existing open positions and prospective transactions to determine the margin requirement. The new margin requirement is then compared to the then available account equity (cash) to accept or reject the trade. If the funds in the account are sufficient, only the amount equal to the VBM will be frozen so that it is not available for other transactions. The remaining balance is free and available for allocation towards other transactions or withdrawal. For example, in one embodiment, all transactions and withdrawal requests from the account are funneled through the analyzer 116, which then insures that at least an amount equal to VBM remains in the account automatically. Therefore if an attempt is made by an automated or manual process to initiate a transaction, the analyzer will only allow transactions to go forward that leave an amount VBM in the account. Similarly, if a customer attempts to withdraw funds in the account he is not allowed to deplete the account below the amount VBM. If an attempt is made to fulfill a transaction or withdraw funds that leave an insufficient amount in the account, the analyzer 116 aborts the trade flow without any additional encumbering. The resulting actions are messaged back via appropriate notices (for email, SMS texting, and online display alarms) to the customer, broker, etc.

In another embodiment, an accountholder has open positions in his account. As the market price of the underlying asset changes, the available equity is compared to the margin requirement. If due to an adverse change in market price, there is insufficient available equity to maintain the VBM amount determined requirement, the account would be subject to position liquidations or additional cash deposit, and/or an alert notice, such as an email, an SMS message, an on-line display, a telephone call, a page, or a FAX may be generated for delivery.

In another embodiment of the present invention, an accountholder's account has at least one open position. The method of the present invention includes monitoring available equity and margin relative to requirements. If due to an adverse change in market price, the available equity relative to the requisite margin determined by the present invention crosses a dealer selected liquidation threshold, the method of the present invention initiates a transaction to being the margin requirement in line with available funds. Again, an alert notice, such as an email, an SMS message, an on-line display, a telephone call, a page, or a FAX, may be generated for delivery.

In another embodiment of the present invention, a portfolio with open account positions uses a liquidity provider for reasons such as for hedging. If due to an adverse change in market price, the Value at Risk exceeds the dealer's risk parameters, an alert notice, such as an email, an SMS message, an on-line display, a telephone call, a page, or a FAX is generated for delivery.

As discussed above the two variables are collected by analyzer and output 116 which then analyzes them and presents them to the user. The user then takes action in accordance with the embodiments set forth above.

Numerous modifications may be made to the invention without departing from its scope as defined in the appended claims. For example, although the system is shown as having separate VBM and VaR parameters, it may be modified if desired so that only one of these parameters are calculated and provided to the analyzer and result output 116.

1. A method for monitoring account reserves in a financial account comprising the steps of:
storing a listing of leveraged financial instruments in an electronic memory;
electronically receiving over an electronic network data from a remote source relevant to said leveraged financial instruments;
generating a plurality of scenarios using a scenario generator, each scenario corresponding to a predetermined deviation from a current price of a leveraged financial instrument;
determining requisite account reserve based upon a mitigating risk corresponding to each of said scenarios; and
generating an electronic indication of said requisite account.

2. The method of claim 1, wherein said requisite account reserve is further determined based upon calculating a volatility rate as a function of a margin rate.

3. The method of claim 1, wherein net liquidating value is calculated as available cash plus the present value of a portfolio of assets.

4. The method of claim 1, wherein said risk scenarios are arranged parametrically and a portfolio value and risk is determined for each scenario.

5. The method of claim 4, wherein said requisite account reserve is further determined based upon the greatest portfolio risk among the risk scenarios.

6. A method for monitoring an account to assure adequate reserves for automated commodity trades comprising the steps of:
electronically storing in a computer-readable medium transactional data corresponding to a contemplated trade;
calculating a net liquidating value as available cash plus the present value of a portfolio of assets contained in said account:
calculating a volatility rate as a function of a margin rate for leveraged financial instruments;
creating a parameter array for a plurality of risk scenarios using a current price of said leveraged financial instruments and predetermined deviations of said current price;
calculating a portfolio value for each of the risk scenarios;
calculating a portfolio value change for each of the risk scenarios based on said deviations;
calculating a portfolio risk for each of the risk scenarios;
selecting the greatest portfolio risk among the risk scenarios; and
generating an output indicative of whether the account has a sufficient funds to obtain more leveraged financial instruments.

7. A system for determining a margin in a brokerage account comprising:
a current price calculator receiving a current price for a leveraged financial instrument and generating a plurality of volatility parameters based on said current price and a plurality of differential factors related to respective margin rates;
a first account value calculator that generates a portfolio value based on each of said volatility parameters, said account value calculator generating a first overall parameter based on said portfolio value; and
an output generator generating an output indicative of the margin of said brokerage account based on said overall parameter.

8. The system of claim 7 wherein said first account value calculator is arranged to generate said first overall parameter indicative of a value based margin for said account.

9. The system of claim 7 wherein said first account value calculator is arranged to generate a first overall parameter indicative of a value-at-risk for said account.

10. The system of claim 7 wherein said first account value calculator is arranged to generate said first parameter indicative on a value based margin, said system further including a second account value calculator generating a second overall parameter indicative of a value-at-risk for said account.
